(19) United States
(12) Patent Application Publication
(10) Pub. No.: US 2004/0067335 A1
(43) Pub. Date: Apr. 8, 2004

(54) Repair of damaged concrete columns or other structures using fast-curing, fiber-reinforced polymer composites

(76) Inventors: Guoqiang Li, Baton Rouge, LA (US); Su-Seng Pang, Baton Rouge, LA (US)

Correspondence Address: PATENT DEPARTMENT, TAYLOR, PORTER, BROOKS & PHILLIPS, L.L.P, P.O. BOX 2471, BATON ROUGE, LA, 70821-2471, US

(21) Appl. No.: 10/266,861

(22) Filed: Oct. 7, 2002

(51) Int. Cl. B32B 27/04; B32B 5/12; B32B 17/04

(52) U.S. Cl. 428/114; 442/149; 442/179; 442/180; 442/181; 428/294.7; 428/299.1; 428/299.4; 156/71

(57) ABSTRACT

A composition of matter and method for inducing the rapid strengthening of damaged structures (e.g., buildings, bridges, dams, etc.) by reducing the application and curing times without the need to apply heat and pressure. The composition of matter comprises a strengthening fabric and a bonding agent which may be cured with ultraviolet light, such as sunlight, in less than about 30 min. The strengthening fabric comprises fibers chemically compatible with the bonding agent, and oriented to allow the bonding agent to quickly diffuse through the fabric.

This invention pertains to a composition of matter and a method that enhances the strengthening of damaged structures, particularly the rapid repair of reinforced cement concrete columns using an ultraviolet (“UV”) curing resin.

For at least two decades, there have been mounting concerns over the safety of the deteriorated bridges in the United States. Among the 600,000 highway bridges in the U.S., about one-half are concrete bridges, which deteriorate for several reasons, such as internal reinforcement corrosion, freeze-thaw action, excessive loading, lack of maintenance, and poor initial design. The Federal Highway Administration (“FHWA”) estimates that about 40% of these bridges are functionally or structurally deficient, and that the cost for maintaining these bridges will be approximately $300 billion. In order to provide an efficient highway network, these deteriorated bridges need to be strengthened or upgraded, so that they may meet the same safety requirements established for new bridges. See Bakis, et al., “Fiber-Reinforced Polymer Composites for Construction—State-of-the-Art Review,” Journal of Composites for Construction, vol. 6., no. 2, pp. 73-87 (2002).

The 21^{st} century mandates the use of innovative materials such as fiber reinforced polymers (“FRP”) to retrofit and upgrade deteriorated bridges. The external bonding of FRP sheets onto the surface of concrete columns has attracted worldwide interest in strengthening and retrofitting deteriorated bridges due to their strength/stiffness to weight ratio and excellent corrosion resistance. Since their development, the use of FRPs in civil infrastructure applications has undergone extensive studies on various factors, including design methods, construction techniques, mechanical properties, and durability. See C. E. Bakis et al., 2002; G. Li et al., “Stiffness Degradation of FRP Strengthened RC Beams Subjected to Hygrothermal and Aging Attacks,” Journal of Composite Materials, vol. 36, no. 7, pp. 795-812 (2002); H. Toutanji et al., “Performance of Concrete Columns Strengthened with Fiber Reinforced Polymer Composite Sheet,” Advanced Composite Materials, vol. 10, no. 2-3, pp. 159-168 (2001) and M. Shahawy et al., “Tests and Modeling of Carbon-wrapped Concrete Columns,” Composites Part B: Engineering, vol. 31B, no. 6/7, pp. 471-480 (2000).

Toutanji et al., “Performance of Concrete Columns Strengthened with Fiber Reinforced Polymer Composite Sheet,” Advanced Composite Materials, vol. 10, no. 2-3, pp. 159-168 (2001) describes a strengthening technique called “wet lay-up” that uses ambient environment curing resins to repair damaged concrete structures. However, ambient environment curing resins have several disadvantages. For example, damaged concrete structures such as bridges and buildings, the structures usually must be closed until the resin cures, which can take up to 7 days. Closing bridges to through traffic causes delays, and subjects road users to significant costs. Additionally, in the event of an earthquake or other natural disaster, a 7-day curing period would hamper efforts to prevent further damage. See also Li et al., 2002.

An alternative technique to repair damaged structures involves the use of “prepreg tape,” a tape made from fibers pre-coated with a polymer resin. Prepreg tape is widely used to repair damaged composite structures because of its advantages over ambient environment curing resins. For example, depending on the materials and the curing process used, prepreg tape may be cured in 90 to 180 min by applying heat (135° C.-190° C.) and pressure (0.17 MPa-0.28 MPa). It may be manufactured in a variety of forms (e.g., roll, sheets, cut forms, etc.), and is flexible enough to be wrapped to a substrate surface. Prepreg may be stored at room temperature for 30 days, or if kept frozen, for up to 1 year. With prepreg tape, fabricators are no longer burdened with the task of mixing the resin components, or combining the resin with the fibers prior to use. However, the addition of heat and pressure for curing may cause several problems to field-level repair. For example, a large amount of power supply is required to produce the required high temperature, which may easily exceed the capability of power supply. Additionally, the potential for fires is increased because of the need for heat. The temperature has to be precisely controlled to assure uniform curing, which is difficult for field level repair. Furthermore, pressurization of FRP layers is quite difficult when coupled with the task of heating the prepreg tape. See Ahn et al., “Repair of Composite Laminates-I: Test Results,” Journal of Composite Materials, vol. 32, no. 11, pp. 1036-1074 (1998); and Li et al., “Investigation of Prepreg Bonded Composite Single-lap Joint,” Composite Part B: Engineering, vol. 32, no. 8, pp. 651-658 (2001).

Until recently, UV-curing resins were mainly used in dental applications because of the short time in which the resin could be cured. The development of UV-curing aerobic acrylic adhesive now allows for the bonding of polymers. Additionally, recent photocatalyst inventions have led to the development of UV-curing resin formulations that cure with UV light, visible light, or both. See Bachmann et al., “UV Structural Adhesives and Sealants—How They Are Unique in the Larger Universe of Photocuring Resin,” Adhesive Age, vol. 43, no. 2, pp. 20-23 (1999). While UV-curing resin has been used to reduce the time required to bond components such as polymers, it has not previously been used to strengthen load-bearing structures (cement concrete, metal, etc.). Traditionally, damaged load-bearing structures have been repaired with steel plates. See Ramirez, “Ten Concrete Column Repair Methods,” Construction and Building Materials, vol. 10, no. 3, pp. 195-202 (1996). Owing to the heavy weight, corrosion, and complication of construction technology, researchers and engineers have been concerned about repairing damaged structures using steel plates. Confronted with these challenges, researchers have been investigating the repair of damaged structures using FRPs for the past 10-15 years. However, these investigations have been limited to using ambient-environment curing resins with polymers. This system has significant advantages over traditional repair methods (e.g., using steel plates to repair damaged structures), such as its light weight, corrosion resistance, and ease of installation. However, very few researchers have questioned the time period needed to cure the FRPs (typically around 7 days)—because, by contrast, the traditional repair method using steel plates may take up to several weeks due to the weight of the steel plates and the complicated installation process.

A need exists for a composition of matter and a method for creating a fiber-reinforced polymer that is practical for considerably more rapid field repairs, and that enhances the strengthening of damaged structures, without the need for applied heat and pressure.

We have discovered a novel composition of matter and method that are suited for the rapid strengthening of damaged structures (e.g., buildings, bridges, dams, etc.) without having to apply heat and pressure. The composition has a rapid curing time, and a relatively high reinforcement efficiency. The composition comprises a bonding agent and a strengthening fabric. The bonding agent may be cured with UV light, for example, from sunlight. The strengthening fabric comprises fibers that are chemically compatible with the bonding agent, and are oriented to allow the bonding agent to quickly diffuse through the fabric, such as E-glass fabric, S-glass fabric, aramid fibers, and carbon fibers. We have used UV-curing FRP with E-glass fabric to strengthen reinforced cement concrete (“RC”) in about 20 min. This composition may be used to reinforce damaged structures made of various types of materials, such as cement concrete and metal, as long as the material(s) and the composition of matter are chemically compatible.

The general purpose of this invention is to provide a reliable, inexpensive method to rapidly repair damaged load-bearing structures (e.g., buildings, bridges, dams, etc.). To induce the rapid repair of damaged structures, the bonding agent comprises a resin that is capable of curing within a short time period (within an hour, preferably less than about 30 min, most preferably between about 10 min and about 20 min), and that will bond to the damaged structure when combined with a strengthening fabric (e.g., E-glass fabric, S-glass fabric, aramid fibers, or carbon fibers). (Commercial sources for these strengthening fabrics: Corning Incorporated, New York, N.Y.; Hexcel Corporation, Stamford, Conn.; and DuPont Global Headquarters, Wilmington, Del.) Various types of UV-curing resins characterized as thermoset resins (e.g., vinyl ester, unsaturated polyester, and phenolic) are chemically compatible with glass fibers and concrete, and thus may be used for repair purposes. See J. M. Berthelot, “Composite Materials: Mechanical Behavior and Structural Analysis,” pp. 15-20 (Springer-Verlag, New York, 1999). (Commercial sources for these UV-curing resins: DYMAX Corporation, Torrington, Conn.; and Sunrez Corporation, El Cajon, Calif.) A resin and a fabric are said to be “chemically compatible” for use on a structure if the polymer bonds well to both the fabric and the structure, and if no component of the FRP structure composite undergoes a substantial degree of chemical degradation under expected environmental conditions during the normal working lifetime of the structure. To ensure that the UV-curing resin can hold the fibers in the strengthening fabric tightly during the loading process and that the two can work together to strengthen a damaged structure, the tensile strength of hardened resins should be greater than about 40 MPa, preferably between about 60 MPa to about 80 MPa, while that of the strengthening fabric should be greater than about 2 GPa, preferably between about 3 GPa to about 5 GPa. To ensure mechanical compatibility between the UV-curing resins and the strengthening fabric, the tensile modulus of elasticity of hardened resins should be greater than about 2 GPa, preferably between about 3 GPa to about 5 GPa, while that of the strengthening fabric should be greater than about 70 GPa, preferably between about 100 GPa to about 200 GPa.

In one embodiment of the novel composition of matter, the “UV-curing resin FRP” allows for the rapid repair of chemically-compatible damaged structures by reducing the resin application time and curing time. In this embodiment, the novel method comprises the steps of: applying a sufficient amount of UV-curing resin in the vicinity of the weakened or failed area of a damaged structure; placing strengthening fabric (e.g., E-glass fabric, S-glass fabric, aramid fibers or carbon fibers) over the UV-curing resin; repeating in layers until a sufficient layering of FRP has been achieved; and curing the FRP layering for approximately 20 min. The type and quantity of the UV-curing resin, and the type of the strengthening fabric should be such that when the strengthening fabric is placed over UV-curing resin, the resin will diffuse through the fabric without excessive trickling. To achieve resin diffusion without excessive trickling, the viscosity of the UV-curing resin is preferably less than about 500 cps. Once diffusion has occurred, the mixture of UV-curing resin and strengthening fabric may be chemically bonded with the damaged structure by exposing the mixture to generated UV light, to sunlight, or to both. Depending on the extent of the damage in the structures, several layers of FRP may be needed to recover sufficient strength. The number of FRP layers may, for example, be determined by a structural analysis using the mechanics of reinforced concrete structures, or by a finite element analysis. The fiber orientation of the strengthening fabric (i.e., the pattern and direction(s) in which the fibers extend) depends on the stresses developed in the structure when subjected to the various types of loads that the structure is designed to support (e.g., tensile, compressive, bending, and torsion). For example, to strengthen a structure designed to withstand both tensile and compressive stresses (e.g., a column under compression load that will experience both axial compressive stress and hoop tensile stress), a plain weave fabric maybe used. In plain weave (also known as “taffeta”), each warp thread and each weft thread passes over one thread and under the next, leading to a stable fabric with good resistance to distortion. To strengthen a structure designed to undertake tensile stress only (e.g., a beam under transverse bending loads), a unidirectional weave fabric with fibers in the tensile stress direction may be used. In unidirectional weave, the threads are aligned in the warp direction, and the warp threads are held together by fine weft threads.

The novel composition has several advantages. First, the UV-curing resin FRP may be used to strengthen any structure with which the UV-curing resin is chemically compatible, such as cement concrete, metal, ceramics, etc. Second, the UV-curing resin allows for the convenient application of FRPs to concrete structures. Unlike epoxy FRPs, which must be brushed and rolled repeatedly to remove entrapped air bubbles and to diffuse the resin through the repair fabric, UV-curing resins typically have a low viscosity, so the resin diffuses without the need for any assistance. Third, a UV-curing resin FRP allows for the rapid strengthening of concrete structures by reducing the overall curing time. Once the UV-curing resin FRP has been applied to the concrete structure, it may be cured in about 20 min. Fourth, unlike prepreg FRPs, which require the application of heat and pressure to cure, the UV-curing resin FRP may be cured by simply exposing it to sunlight. Finally, the UV-curing resin FRP reduces the cost for strengthening structures because UV-curing resin is relatively inexpensive.

### EXAMPLE 1

Raw Materials

Three types of resins were used to make FRPs. The first resin was a two-part high strength epoxy adhesive (3M Scotch-Weld® 1838 B/A green: 3M Industrial Tape and Specialties Division, St. Paul, Minn.), which may be cured in 24 hr at room temperature when mixed in a 1:1 ratio by weight. The second resin was an ultraviolet curing resin (“UV-curing resin”) (UV-curing vinyl ester: Sunrez Corporation, El Cajon, Calif.), which may be cured by UV light or sunlight in 20 min. The third resin was an E-glass 7781 style fabric reinforced phenolic prepreg (L-526 prepreg: JD Lincoln, Inc., Costa Mesa, Calif.), which may be cured in 1.5 hr at 135° C. For comparison purposes, E-glass 7781 fabric was also used to reinforce the epoxy and UV-curing resins. The physical properties of the raw materials used are shown in Table 1.

TABLE 1
Physical/Mechanical Properties of the Raw Materials

| | | Tensile | |
|---|---|---|---|
| | Viscosity at | Strength | Modulus of |
| Materials | 25° C. (cps) | (MPa) | Elasticity (GPa) |
| Epoxy Adhesive | 300,000 | 83 | 3.8 |
| UV-Curing Resin | 500 | 70 | 4.2 |
| Prepreg^{†} | — | 330 | 24.8 |
| E-glass 7781 Style Fabric^{†} | — | 3,000 | 70.0 |

^{†}Viscosity was too high to be measured

Two different concrete mixtures were made out of Type I Portland cement, fine aggregates, water, and an air-entraining admixture. The concrete mixtures (hereinafter referred to as batches “A” and “B”) had design strengths of 27 MPa and 36 MPa, respectively. The corresponding mixture ratios by weight were cement:water:fine aggregate:sand:admixture=1:0.48:3.31:1.97:0.001, and 1:0.44:1.76:3.21:0.001, respectively. Each batch of concrete was tested for slump (i.e., a control test that indicates the uniformity of the concrete mix from one batch to the next), air content, and 28-day compressive strength. The test results are shown in Table 2. Grade 60 steel (Steel Rebar: Lulich Steel Corporation, Slidell, La.) having a yield strength of 414 MPa and an elastic modulus of 200 GPa was used to reinforce the concrete.

TABLE 2
Test Results of Concrete

Batch

| | A | B |
|---|---|---|
| 28-day Compressive Strength (MPa) | 26.1 | 35.8 |
| Slump (cm) | 15.2 | 5.7 |
| Air Content (%) | 8.1 | 5.3 |

Specimen Fabrication

Twenty-four steel-reinforced concrete (“RC”) columns were designed, cast, and cured in a controlled environment for 28 days. The RC column dimensions were 152.4 mm×609.6 mm in diameter and length, respectively. RC columns C1-C12 were cast from concrete batch A, while RC columns C13-C24 were cast from batch B. To meet the requirements of Code 318 of the American Concrete Institute (“ACI”) for strength, minimum steel, and maximum spacing, the longitudinal reinforcement was made out of six #4 (12.7 mm dia.) rebar, while the confinement reinforcement was made out of twelve #3 (9.5 mm dia.) rebar shaped into circular rings, and spaced 50.8 mm apart.

Pre-Cracking of RC Columns

To simulate heavily damaged RC columns, and to fully display the confinement capability of the FRPs made out of epoxy adhesive, UV-curing resin, and prepreg, all the RC columns (except C1, C2, and C13, which were used to determine the ultimate capacity of undamaged columns) were pre-cracked using a split tensile test (i.e., applying a continuous load to the samples until split tensile failure occurred). The split tensile test was conducted as described in the American Society for Testing and Materials (“ASTM”) C 496 standard. Once pre-cracking was complete, dust and floating aggregates were removed using an angle grinder.

### EXAMPLE 2

Repair of Damaged RC Columns

To demonstrate the effectiveness of the novel FRP process, pre-cracked RC columns were repaired using the wet lay-up and heat activated curing prepreg techniques. Both the epoxy and the UV-curing resins were applied using the wet lay-up technique. To apply the first FRP repair layer, a layer of resin (about 300 g/m² for epoxy-repaired RC columns and about 200 g/m² for UV-curing resin-repaired RC columns) was applied onto the surface of the pre-cracked RC columns. E-glass fabric having a length (axial direction) of 558 mm and a width (hoop direction) of 530 mm was wrapped around the RC columns. A 50 mm long segment of E-glass fabric was applied in the hoop direction to overlap the first layer of fabric in order to provide a continuous load transfer in the hoop direction. A steel roller (Concrete Roller: Master Builders, Inc., Cleveland, Ohio) was then used to remove entrapped air bubbles, and to press the resin into the E-glass fabric until the resin diffused through the fabric. (A roller is not required to apply UV-curing resin because of its low viscosity.) Afterwards, another layer of resin was applied to the E-glass fabric. To apply a second FRP repair layer, the procedure was repeated.

The viscosity of the UV-curing resin was sufficient to diffuse through the fabric without generating excessive trickling. Once the RC columns were wrapped, the epoxy FRP samples were cured inside the lab for 24 hr, while the UV-curing resin FRP samples were brought outside, and exposed to direct sunlight for 1 hr. The total curing time for UV-curing resin had to be extended from 20 min to 1 hr because only about one-third of the RC column surface could be exposed to the sunshine at one time. The RC columns were turned every five minutes for 1 hr to achieve curing uniformity.

Pre-cracked RC columns were then repaired using the heat activated curing prepreg technique. A composite beam joining procedure was used to apply the prepreg to the RC columns. Two rounds of prepreg having a length (axial direction) of 558 mm and a width (hoop direction) of 1,010 mm were wrapped onto the surface of the RC columns to form two layers. A 50 mm long segment of prepreg was applied in the hoop direction to overlap the first two layers of prepreg. Pressure was applied to the prepreg by wrapping shrink tape (Hi-Shrink Tape: Dunstone Company, Inc., Charlotte, N.C.) around the prepreg layer in a spiral pattern. The RC columns were then placed in an oven and cured at 135° C. for 1.5 hr. See Ahn et al., 1998; and Li et al., 2001.

Conditioning of Specimens

To investigate the hygrothermal durability and the feasibility of the FRP repairs, the RC columns (also referred to as “specimens”) were conditioned using boiling seawater and UV radiation. To condition the specimens in seawater, an aluminum tank having dimensions of 180 cm×100 cm×60 cm was used as a conditioning chamber. The seawater contained 2.5% NaCl by weight, as described in the ASTM 1183 standard. The four sides and the bottom surface of the tank were wrapped with insulation foam (Foil-Faced Fiberglass Insulation: Cameron Ashley, Greer, S.C.) to reduce heat loss. The lid was made out of 2.5 cm thick plywood to reduce heat dissipation. Two 3 kW PTHF-302 water heaters (OMEGA Engineering, Inc., Stamford, Conn.) were used to boil the seawater. A 300 W Mog Base UV lamp (UV Process Supply, Inc., Chicago, Ill.) having a wavelength ranging from 280 to 340 nm was used to condition the specimens in UV radiation.

Nine RC column repaired samples (three epoxy-repaired, three UV-curing resin-repaired, and three prepreg-repaired RC columns) were placed into the boiling seawater for 7 days. (A conditioning time of 7 days was chosen to saturate the FRP layers, so that the test results could be used to predict how FRP layers would degrade over an extended period.) The details of each test sample are shown in Table 3. See Li et al., 2002; Hale et al., “Tensile Strength Testing of GRP Pipes at Elevated Temperatures in Aggressive Offshore Environments,” Journal of Composite Materials, vol. 32, no. 10, pp. 969-986 (1998).

TABLE 3
Details of Test Samples

| Sample | Concrete | Repair | |
|---|---|---|---|
| Number | Group | Method | Conditioning |
| C1 | A | UDC | No |
| C2 | A | UDC | No |
| C3 | A | DC | No |
| C4 | A | Prepreg | No |
| C5 | A | Prepreg | No |
| C6 | A | Prepreg | No |
| C7 | A | Epoxy | No |
| C8 | A | Epoxy | No |
| C9 | A | Epoxy | No |
| C10 | A | UV-curing | No |
| C11 | A | UV-curing | No |
| C12 | A | UV-curing | No |
| C13 | B | UDC | Yes |
| C14 | B | DC | Yes |
| C15 | B | DC | Yes |
| C16 | B | Prepreg | Yes |
| C17 | B | Prepreg | Yes |
| C18 | B | Prepreg | Yes |
| C19 | B | Epoxy | Yes |
| C20 | B | Epoxy | Yes |
| C21 | B | Epoxy | Yes |
| C22 | B | UV-curing | Yes |
| C23 | B | UV-curing | Yes |
| C24 | B | UV-curing | Yes |

UDC = Undamaged control sample
DC = Pre-damaged control sample

Uniaxial Compression Test

After the 9 samples were conditioned, all the samples were uniaxially compressed using an Instron MTS machine (Instron, Canton, Mass.) to determine the modulus of elasticity and compressive strength of the control samples and repaired samples, as described in the ASTM C469 standard. The compressive strength test was conducted as described in the ASTM C39 standard.

Residual Mechanical Properties of the FRPS

To determine the effectiveness of the resins used to make the FRPS (epoxy, UV-curing resin, and prepreg), and the effects of environmental conditioning, the residual mechanical properties of the FRPS were assessed by a tension test, as described in the ASTM D3096-76 standard. Once the uniaxial compression tests of the specimens were complete, test coupons (i.e., 203.2 mm long by 50.8 mm wide samples), were cut from the FRP repair layers in the axial direction using a rotary cutter (Dremel, Racine, Wis.). To minimize the effect of damage in the FRP layers on the coupon test results, the coupons were cut at a location 50 mm away from the broken line of the FRP layers. This ensured that the effect of the FRP cracks on the mechanical properties of the coupons could be neglected. Six coupons (three unconditioned and three conditioned repair samples) for each type of FRP were prepared. RESULTS

Effect of Pre-cracking on the Ultimate Capacity of RC Columns

Pre-cracking significantly reduced the compressive strength of the RC columns. Only 22% of the original compressive strength was retained by the RC columns prepared from concrete batch A, and only 25% of the original compressive strength was retained by the RC columns prepared from concrete batch B, as shown in Table 4. The disintegration of the concrete by the pre-cracking caused a loss of the lateral confinement of the reinforcing steel, reducing the load carrying capacity of the RC columns. The remaining compressive strength of the pre-cracked specimens was so low that they could not safely be used to support structural loads. This clearly demonstrated the necessity of repairing or jacketing the damaged RC columns.

Enhancement of the Load Carrying Capacity of Pre-cracked RC Columns by Externally Bonded FRP Fabrics

The FRP repairs (epoxy-repaired, UV-curing resin-repaired, and prepreg-repaired RC columns) substantially increased the compressive strength of the pre-cracked RC columns, as shown in Table 4. A 2-layer application of the FRPS was all that was required to completely recover the lost compressive strength in each repaired sample. The compressive strength of the UV-curing resin FRP samples was 4.86 times the strength of the pre-cracked control samples, while the compressive strength of the prepreg FRP and epoxy FRP samples were 5.36 and 5.30 times the strength of the pre-cracked control samples, respectively.

TABLE 4
Average Compressive Strength of Various Samples
With and Without Environmental Conditioning (MPa)

| | | Pre-Cracked | UV-Curing | | |
|---|---|---|---|---|---|
| Environmental | Control | Control | Resin FRP | Prepreg FRP | Epoxy FRP |
| Conditioning | Sample | Sample | Sample | Sample | Sample |
| No | 36.00 | 8.00 | 40.05 | 42.95 | 42.41 |
| Yes | 41.00 | 10.07 | 44.00 | 47.05 | 47.50 |

The modulus of elasticity of the prepreg FRP samples was nearly twice that of both the UV-curing resin FRP and epoxy FRP samples, as shown in Table 5. This is likely due to the pressure applied by the shrink tape during the heat-activated curing process, which caused a considerable amount of resin penetration in the cracks and voids of the concrete, resulting in improved interfacial bonding. As a result, the stiffness of the prepreg FRP samples was considerably higher than that of the UV-curing resin FRP and epoxy FRP samples. However, the improved interfacial bonding did not increase the compressive strength substantially. As shown in Table 4, the compressive strength of prepreg FRP samples was only slightly higher than that of the UV-curing resin FRP and epoxy FRP samples. This result coincides with previous studies indicating that increased interfacial bonding does not substantially increase the compressive strength of a repaired RC column. See Shahawy et al., 2000.

TABLE 5
Average Modulus of Elasticity of Various Repaired
Samples with and Without Environmental Conditioning (MPa)

| Environmental | UV-Curing Resin | Prepreg FRP | |
|---|---|---|---|
| Conditioning | FRP Sample | Sample | Epoxy FRP Sample |
| No | 6,411 | 11,790 | 6,383 |
| Yes | 7,805 | 14,095 | 9,211 |

Degradation of the Load Carrying Capacity of FRP Repaired RC Columns due to Environmental Conditioning

As shown in Table 4, the FRP repairs increased the compressive strength of the pre-damaged columns considerably, even though the repairs were subjected to environmental conditioning (boiling seawater and UV radiation). However, the environmental conditioning reduced the reinforcing efficiency of the FRPS somewhat. This may be seen through a comparison of the reinforcing efficiency of the unconditioned specimens with those of conditioned specimens. The reduction of reinforcing efficiency was 14.6% for UV-curing resin, 17.2% for heat-activated curing prepreg, and 17.2% for ambient environment-curing epoxy. Reduction in reinforcing efficiency may also be validated using the residual strength test of the FRP coupons cut from the repaired columns. As shown in Table 6, about 12.5% of the peak load for the UV-curing resin FRP samples was lost after conditioning, as compared to 15.3% for prepreg FRP and 14.9% for epoxy FRP samples.

As shown in Table 5, the modulus of elasticity behaved similarly in the conditioned and unconditioned samples. Prepreg FRP samples had a modulus nearly twice that of the UV-curing resin FRP and epoxy FRP samples. From Table 5, it seems that the stiffness of the specimens with conditioning is higher than that without conditioning. This is because the actual modulus of elasticity values of the conditioned samples was larger than that of the unconditioned samples. The larger stiffness of the repaired samples was due to the stronger batch of concrete used to cast the conditioned samples. The conditioning actually reduced the stiffness of the FRPS, as shown in Table 6.

TABLE 6
Residual Mechanical Properties of FRPS

| | | Peak Load | |
|---|---|---|---|
| Materials (FRPS) | Conditioning | (kN) | Modulus of Elasticity (GPa) |
| Epoxy | No | 6.12 | 19.2 |
| | Yes | 5.20 | 17.0 |
| UV-Curing Resin | No | 5.50 | 18.8 |
| | Yes | 4.81 | 16.7 |
| Prepreg | No | 6.20 | 19.8 |
| | Yes | 5.25 | 17.1 |

FRP degradation may be attributed to several factors. First, water absorption at elevated temperatures may have accelerated water diffusion, causing rapid degradation of the FRP. Moreover, penetration of water into the FRP occurs by diffusion through the matrix resin and capillary flow via microcracks and voids, which could lead to the development of residual stress and plasticization of the resin, and debonding at the fiber/matrix interface. Second, salt may have further weakened the fiber/matrix interfacial bonding, and attacked the E-glass fibers. Third, the ultraviolet radiation may have broken chemical bonds in organic molecules, causing matrix brittleness and cracking, and increasing fiber/matrix interfacial debonding, and thus reducing the mechanical strength of the FRPS. Ultraviolet radiation conditioning had a lesser effect on UV-curing resin.

Failure Mode Analysis

Under a uniaxial compressive load, both axial compressive stress and hoop tensile stress were developed in the FRP layers. Once the hoop tensile stress surpassed the tensile strength of the FRP composites, the FRP layers fractured. Thus, the sudden mechanical failure of all the repaired samples was due to the tensile failure of the FRP layers (epoxy, UV-curing resin, and prepreg), which initiated from about one-eighth the height of the column to about the middle of the column. Although the FRPS failed suddenly, the sound produced from fiber breakage was clearly heard before mechanical failure occurred. Examination of the broken surfaces of the FRP layers indicated that fiber/matrix interfacial bonding was good. Additionally, no debonding was observed between the FRP layers, indicating that the FRP was well laminated, and that the construction techniques were adequate. Furthermore, a thin layer of concrete was observed attached to the FRP layers, indicating that the epoxy resin, UV-curing resins and prepregs were chemically compatible with the concrete. With FRP confinement, only the concrete within the FRP broken zone was disintegrated. The majority of the column was still integral. This was because once the damage was initiated in the FRP layers, stress concentrated around the damaged zone in the neighboring concrete. This stress caused further damage to the already weakened area. Therefore, the damage was localized, and only the concrete within the FRP broken zone was disintegrated.

Cost/Benefit Analysis

The benefits of using epoxy, UV-curing resin and prepreg FRP repairs, in terms of regaining lost strength, are virtually identical. A cost/benefit analysis would, therefore, mainly depend on the price of materials and labor. A rough estimate of the cost per repaired sample is shown in Table 7. Table 7 considers only the material costs, not including the labor costs and costs expended by drivers because of traffic delays caused by the repairs. As shown in Table 7, the price using UV curing FRP is about 50% of the price using prepreg FRP, and about 8% of the price using epoxy FRP. Obviously, the cost of using UV curing resin FRP is very low. Considering the reduced repair time, ease of installation, and time saving on road users, the UV curing resin FRP is a cost-effective and novel repair method.

TABLE 7
Rough Estimate of the Raw Materials Cost for Repairing Per Column

| Repair | | Cost Per | Units Used | | Total Cost |
|---|---|---|---|---|---|
| Method | Item | Unit | Per Sample | Cost Per Item | Per Sample |
| Epoxy | Epoxy | $148/L | 0.394 L | $58.31 | |
| | Fabric | $3.60/m² | 0.569 m² | $2.05 | |
| | | | | | $60.36 |
| Prepreg | Prepreg | $15.79/m² | 0.569 m² | $8.97 | |
| | Sheet | | | | |
| | Shrink | $2/roll | 0.5 roll | $1.00 | |
| | Tape | | | | |
| | Electricity | $0.08/kWh | 9 kWh | $0.72 | |
| | | | | | $10.69 |
| UV-curing | Resin | $7.93/L | 0.37 L | $3.00 | |
| | Fabric | $3.60/m² | 0.569 m² | $2.05 | |
| | | | | | $5.05 |

### CONCLUSION

From the above tests, several conclusions were made. First, the heat-curing prepreg and UV-curing resin achieved nearly the same reinforcing efficiency as the ambient environment curing epoxy, at a substantially lower cost. Second, the time required to repair the RC columns with UV-curing resin was substantially less than that for either prepreg or epoxy. Third, while the interfacial bonding of the prepreg FRP samples was considerably higher than that of the UV-curing resin FRP and epoxy FRP samples, the compressive strength of prepreg FRP samples was only slightly higher than that of the UV-curing resin FRP and epoxy FRP samples. Fourth, the level of deterioration due to hygrothermal conditioning was less in the UV-curing resin FRP samples (approximately 14.2%) than in the heat-curing prepreg FRP and ambient environment curing epoxy FRP samples (approximately 17.2% for both). Finally, all the FRPS tested, including the FRP made from UV-curing resin, were chemically compatible with the concrete.

The complete disclosures of all references cited in this specification are hereby incorporated by reference. Also incorporated by reference is the complete disclosure of the following paper: G. Li et al., “Repair of Damage RC columns Using Fast Curing FRP Composites,” which was accepted for publication by Composite Part B: Engineering on Sep. 6, 2002. Also incorporated by reference is the complete disclosure of the following abstract presented by the inventors: N. Pourmohamadian et al., “Fast Repair of Laminated Beams Using UV Curing Composites,” Proceeding of ICCE/9, San Diego, July 1-6, pp. 633-634 (2002). Also incorporated by reference is the complete disclosure of the following paper: G. Li et al., “Fast Repair of Laminated Beams Using UV Curing Composites,” which was accepted for publication by Composite Structures on Aug. 12, 2002. In the event of an otherwise irreconcilable conflict, however, the present specification shall control.

We claim:

1. A kit for rapidly repairing a damaged structure, wherein the structure comprises at least one material selected from the group consisting of cement concrete and metal, said kit comprising:
(a) a bonding agent capable of being cured with ultraviolet light; and
(b) a strengthening fabric comprising fibers chemically compatible with said bonding agent, and adapted to allow the bonding agent to diffuse through said strengthening fabric;
wherein:
(c) when said bonding agent and said strengthening fabric are applied to a damaged structure in a sufficient number of layers and fully exposed to ultraviolet light for less than about 30 min, said bonding agent and said strengthening fabric chemically bond with the damaged structure to strengthen the structure.

2. A kit as recited in claim 1, wherein said bonding agent cures in less than about 30 min in full sunlight.

3. A kit as recited in claim 1, wherein said bonding agent cures in about 10 min to about 20 min in full sunlight.

4. A kit as recited in claim 1, wherein said bonding agent is selected from the group consisting of vinyl ester, unsaturated polyester, and phenolic resins.

5. A kit as recited in claim 1, wherein said bonding agent is a vinyl ester resin.

6. A kit as recited in claim 1, wherein said strengthening fabric is selected from the group consisting of E-glass fabric, S-glass fabric, aramid fibers, and carbon fibers.

7. A kit as recited in claim 1, wherein said strengthening fabric is E-glass fabric.

8. A kit as recited in claim 1, wherein said strengthening fabric comprises warp threads and weft threads; wherein said warp thread and said weft threads pass over and under one another to form a plain weave fabric capable of repairing a damaged structure that experiences both axial compressive and hoop tensile stresses.

9. A kit as recited in claim 1, wherein said strengthening fabric comprises warp threads held together by fine weft threads to form a unidirectional weave fabric capable of repairing a damaged structure that experiences transverse bending loads.

10. A kit as recited in claim 1, wherein said kit is adapted to repair a damaged structure comprising cement concrete.

11. A kit as recited in claim 1, wherein said bonding agent has a tensile strength greater than about 40 MPa when fully cured.

12. A kit as recited in claim 1, wherein said bonding agent has a tensile strength between about 60 MPa to about 80 MPa when fully cured.

13. A kit as recited in claim 1, wherein said strengthening fabric has a tensile strength greater than about 2 GPa.

14. A kit as recited in claim 1, wherein said strengthening fabric has a tensile strength between about 3 GPa to about 5 GPa.

15. A kit as recited in claim 1, wherein said bonding agent has a tensile modulus of elasticity greater than about 2 GPa.

16. A kit as recited in claim 1, wherein said bonding agent has a tensile modulus of elasticity between about 3 GPa to about 5 GPa.

17. A kit as recited in claim 1, wherein said strengthening fabric has a tensile modulus of elasticity greater than about 70 GPa.

18. A kit as recited in claim 1, wherein said strengthening fabric has a tensile modulus of elasticity between about 100 GPa to about 200 GPa.

19. A kit as recited in claim 1, wherein said bonding agent before curing has a viscosity less than about 500 cps.

20. A kit as recited in claim 1, wherein said bonding agent and said strengthening fabric chemically bond with the damaged structure to strengthen the structure such that any lost strength in the damaged structure is completely recovered.

21. A method for strengthening a damaged structure comprising at least one material selected from the group consisting of cement concrete and metal, using a kit as recited in claim 1; said method comprising:
(a) applying the bonding agent in the vicinity of a weakened or failed area of the, damaged structure;
(b) placing the strengthening fabric over the bonding agent to form one strengthening layer; and
(c) curing the strengthening layer to form a fiber-reinforced polymer.

22. A method as recited in claim 21, additionally comprising repeating steps (a) and (b) until a sufficient number of strengthening layers have been formed to recover the lost strength in the damaged structure; and then applying step (c) after a sufficient number of strengthening layers have been formed.

23. A method as recited in claim 21, wherein the bonding agent cures in less than about 30 min in full sunlight.

24. A method as recited in claim 21, wherein the bonding agent cures in about 10 min to about 20 min in full sunlight.

25. A method as recited in claim 21, wherein the bonding agent is selected from the group consisting of vinyl ester, unsaturated polyester, and phenolic resins.

26. A method as recited in claim 21, wherein the bonding agent is a vinyl ester resin.

27. A method as recited in claim 21, wherein the strengthening fabric is selected from the group consisting of E-glass fabric, S-glass fabric, aramid fibers, and carbon fibers.

28. A method as recited in claim 21, wherein the strengthening fabric is E-glass fabric.

29. A method as recited in claim 21, wherein the strengthening fabric comprises warp threads and weft threads; wherein the warp thread and the weft threads pass over and under one another to form a plain weave fabric capable of repairing a damaged structure that experiences both axial compressive and hoop tensile stresses.

30. A method as recited in claim 21, wherein the strengthening fabric comprises warp threads held together by fine weft threads to form a unidirectional weave fabric capable of repairing a damaged structure that experiences transverse bending loads.

31. A method as recited in claim 21, wherein said method is adapted to repair a damaged structure comprising cement concrete.

32. A method as recited in claim 21, wherein the bonding agent has a tensile strength greater than about 40 MPa when fully cured.

33. A method as recited in claim 21, wherein the bonding agent has a tensile strength between about 60 MPa to about 80 MPa when fully cured.

34. A method as recited in claim 21, wherein the strengthening fabric has a tensile strength greater than about 2 GPa.

35. A method as recited in claim 21, wherein the strengthening fabric has a tensile strength between about 3 GPa to about 5 GPa.

36. A method as recited in claim 21, wherein the bonding agent has a tensile modulus of elasticity greater than about 2 GPa.

37. A method as recited in claim 21, wherein the bonding agent has a tensile modulus of elasticity between about 3 GPa to about 5 GPa.

38. A method as recited in claim 21, wherein the strengthening fabric has a tensile modulus of elasticity greater than about 70 GPa.

39. A method as recited in claim 21, wherein the strengthening fabric has a tensile modulus of elasticity between about 100 GPa to about 200 GPa.

40. A method as recited in claim 21, wherein the bonding agent before curing has a viscosity less than about 500 cps.

41. A method as recited in claim 21, wherein the bonding agent and the strengthening fabric chemically bond with the damaged structure to strengthen the structure such that any lost strength in the damaged structure is completely recovered.

42. A fiber-reinforced polymer made by the process of claim 21.

43. A fiber-reinforced polymer made by the process of claim 22.

44. A fiber-reinforced polymer made by the process of claim 23.

45. A fiber-reinforced polymer made by the process of claim 24.

46. A fiber-reinforced polymer made by the process of claim 25.

47. A fiber-reinforced polymer made by the process of claim 26.

48. A fiber-reinforced polymer made by the process of claim 27.

49. A fiber-reinforced polymer made by the process of claim 28.

50. A fiber-reinforced polymer made by the process of claim 29.

51. A fiber-reinforced polymer made by the process of claim 30.

52. A fiber-reinforced polymer made by the process of claim 31.

53. A fiber-reinforced polymer made by the process of claim 32.

54. A fiber-reinforced polymer made by the process of claim 33.

55. A fiber-reinforced polymer made by the process of claim 34.

56. A fiber-reinforced polymer made by the process of claim 35.

57. A fiber-reinforced polymer made by the process of claim 36.

58. A fiber-reinforced polymer made by the process of claim 37.

59. A fiber-reinforced polymer made by the process of claim 38.

60. A fiber-reinforced polymer made by the process of claim 39.

61. A fiber-reinforced polymer made by the process of claim 40.

62. A fiber-reinforced polymer made by the process of claim 41.

63. A strengthened structure made by the process of claim 21.

64. A strengthened structure made by the process of claim 22.

65. A strengthened structure made by the process of claim 23.

66. A strengthened structure made by the process of claim 24.

67. A strengthened structure made by the process of claim 25.

68. A strengthened structure made by the process of claim 26.

69. A strengthened structure made by the process of claim 27.

70. A strengthened structure made by the process of claim 28.

71. A strengthened structure made by the process of claim 29.

72. A strengthened structure made by the process of claim 30.

73. A strengthened structure made by the process of claim 31.

74. A strengthened structure made by the process of claim 32.

75. A strengthened structure made by the process of claim 33.

76. A strengthened structure made by the process of claim 34.

77. A strengthened structure made by the process of claim 35.

78. A strengthened structure made by the process of claim 36.

79. A strengthened structure made by the process of claim 37.

80. A strengthened structure made by the process of claim 38.

81. A strengthened structure made by the process of claim 39.

82. A strengthened structure made by the process of claim 40.

83. A strengthened structure made by the process of claim 41.
